(19) United States
(12) Patent Application Publication
(10) Pub. No.: US 2012/0061877 A1
(43) Pub. Date: Mar. 15, 2012

(54) Hyrdophilic Surface Modification of Polydimethylsiloxane

(75) Inventor: David Britt, Mendon, UT (US)

(73) Assignee: Utah State University, North Logan, UT (US)

(21) Appl. No.: 13/246,660

(22) Filed: Sep. 27, 2011

Related U.S. Application Data
(63) Continuation-in-part of application No. 12/551,722, filed on Sep. 1, 2009, now Pat. No. 8,053,548.
(60) Provisional application No. 61/094,510, filed on Sep. 5, 2008.

(51) Int. Cl. B28B 7/36; B29C 31/10

(52) U.S. Cl. 264/338; 425/130

(57) ABSTRACT

A method for making a hydrophilic polydimethylsiloxane elastomer, the method including: mixing a polydimethylsiloxane elastomer base with a polydimethylsiloxane elastomer curing agent to form a mixture; placing the mixture in a mold coated or permeated with a surfactant; and curing the mixture in the mold.

### RELATED APPLICATIONS

This application is a continuation-in-part of U.S. application Ser. No. 12/551,722, filed on Sep. 1, 2009, which claims the benefit of U.S. Provisional Patent Application Ser. No. 61/094,510, filed on Sep. 5, 2008, both of which are hereby incorporated by reference in their entirety.

### FIELD OF THE INVENTION

This disclosure relates to a method for the preparation of hydrophilic elastomers, and in particular to the synthesis of polydimethylsiloxane with tunable hydrophilic surface properties.

### BACKGROUND OF THE INVENTION

Polydimethylsiloxane (PDMS) is a silicon-based organic polymer that is inert and non-toxic. The mechanical, chemical, and optical properties of PDMS make it a material used in a range of medical related applications, such as artificial organs, prostheses, catheters, contact lenses, and drug delivery systems. Non-medical applications include microfluidic devices, microreactors, lab on chip diagnostics, soft-lithography, membranes, electrical insulators, water repellents, anti foaming agents, adhesives, protective coatings, sealants, and a wide variety of other uses.

PDMS is commercially available from several vendors as a two part kit consisting of an elastomer base and a cross linking agent, both in liquid form. A range of kits are available in which elastomer base molecular weight and/or branching are varied. Polymerization is initiated upon mixing the elastomer base with the cross-linking agent, producing an optically clear rubbery solid PDMS elastomer with hydrophobic surface characteristics. The hydrophobic nature of PDMS is often an undesirable property for various applications stated previously. In particular, microfluidic devices may require hydrophilic surfaces to permit polar liquids to pass through. Biomedical devices, such as contact lenses, that are easily wetted improve user comfort. A variety of strategies have been developed to render the PDMS surface hydrophilic, which include exposure to oxygen plasma, ozone, corona discharge, and ultraviolet light. In addition hydrophilic surface modification has been achieved through physical adsorption of charged surfactants, polyelectrolyte multilayers, and entangling amphiphilic co-polymers using a swelling-deswelling method in organic solvent. Covalent modification of the PDMS surface requires activation of the surface, generally through an oxidative process followed by deposition of the reactive molecule from solvent or chemical vapor deposition. Some of the most widely used methods for production of hydrophilic PDMS are described briefly below. Cost-effective methods to render PDMS hydrophilic that do not compromise mechanical, optical, or gas permeability properties are of the essence.

It is well established in the literature that exposing PDMS to various energy sources can alter its surface properties. Energy sources such as oxygen plasma, ultraviolet light, and corona discharges have been used to create hydrophilic PDMS surface by oxidation. Oxygen plasma and ultraviolet light have been the most widely used methods in modifying PDMS surfaces. However, these methods generate an unstable and brittle hydrophilic glass like silicate surface layer that compromises elasticity and is unstable over time, allowing the PDMS surface to recover its hydrophobic nature.

Chemical grafting of hydrophilic molecules to the surface of PDMS is stable but is difficult to achieve because PDMS is chemically inert. Thus the first step is to render the surface reactive through exposure to an oxygen plasma or other energy source as discussed previously, resulting in a glass-like silicate layer with chemically reactive groups (e.g. hydroxyl groups: —OH) on the surface. Additional surface modification is achieved via chemical coupling of target molecules to the —OH (or other reactive groups) following standard protocols. However, the underlying glass-like layer remains brittle, limiting applications where elasticity is required, and the process requires multiple reaction steps, which can be costly, inefficient, and generate waste in the form of organic solvent.

Physical entanglement of amphiphilic copolymers containing a PDMS chain to serve as an anchor group is achieved via a swelling-deswelling method. In this approach, a cross-linked PDMS monolith is placed in an organic solvent, such as chloroform, resulting in swelling. In the swollen state low molecular weight amphipilic copolymers may penetrate the PDMS surface. Exchanging the solvent for a polar solvent returns the PDMS monolith to its original size. The aim is to embed/anchor the amphiphilic copolymers on the surface of a cross-linked PDMS. Copolymers that may penetrate the surface of the swollen PDMS monolith are likely held in place by van der Waals force and hydrophobic interactions between the PDMS monolith and PDMS segments in block copolymer amphiphiles. The aim is produce a stable hydrophilic surface on PDMS. However, this method is very time consuming and requires an organic solvent such as chloroform to sufficiently swell the PDMS.

From a review of the current literature, there is a need for a simple and cost efficient technique to form a silicon elastomer, namely, polydimethylsiloxane exhibiting hydrophilic character that can be tuned by the preparation conditions and subsequent treatments and exposure environments.

In addition, conventional kits for producing hydrophilic PDMS (such as those available from Sigma-Aldrich) tend to rely on using organic solvents to remove unreacted PDMS from the cured polymer followed by oxygen plasma or UV ozone treatment steps, which are then generally followed by a covalent linking of a hydrophilic polymer to the oxidized PDMS. Disadvantages to these methods are numerous, and include, for example, multiple steps, hazardous solvents, increased cost, and embrittlement of the PDMS surface following oxidation.

### SUMMARY OF THE INVENTION

The present disclosure in aspects and embodiments addresses these various needs and problems by providing efficient and effective materials and methods for producing hydrophilic polysiloxanes, such as hydrophilic PDMS. The methods and materials use a polymeric surfactant additive which may be an amphiphilic block copolymer or an end functionalized polymer. This polymeric surfactant additive may be a linear or branched polymer. It may be comprised of a hydrophobic segment, or anchor, which is compatible with the base elastomer (e.g. PDMS) and serves to solubilize the additive within the elastomer matrix during preparation, and later serves to anchor the additive in the cured polysiloxane. The additive is also comprised of a hydrophilic pendant chain(s), which impart(s) desirable surface properties to the formed elastomer monolith, where van der Waals forces and hydrophobic interactions between the polysiloxane base polymer and polymeric surfactant additive are sufficient to lead to a stable hydrophilic surface. Further, the extent of surface modification of polysiloxane monoliths may be tuned by varying the molecular weight of the polymeric surfactant additive and/or the ratio and/or configuration of hydrophobic anchor to hydrophilic pendant chain(s). In addition to modifying the surface energy of the polysiloxane monolith, the optical properties of the formed polysiloxane monoliths can be tuned by varying factors such as the concentration, molecular weight, configuration, and hydrophobic/hydrophilic balance of the polymer additive(s). In addition, molds and methods of molding polysiloxane monoliths are described.

### BRIEF DESCRIPTION OF THE DRAWINGS

FIG. 1 illustrates exemplary process steps for an exemplary hydrophilic polysiloxane preparation method.

FIGS. 2a, 2b, and 2c are schematic illustrations of the time dependent water contact angle behavior of an exemplary modified polysiloxane.

FIG. 3 shows the temporal variation in water contact angle behavior on exemplary modified polysiloxane surfaces exhibiting hydrophilic characteristics. The surfactant additions are 0=squares, 1%=up triangles, 2%=down triangles, 3%=diamonds, and 5%=circles.

FIG. 4 illustrates the initial contact angle of a drop of water on the surface of an exemplary polysiloxane prepared according to methods described herein.

FIG. 5 illustrates the resulting contact angle of the drop of water on the surface of the exemplary polysiloxane of FIG. 4.

### DETAILED DESCRIPTION OF SELECTED EMBODIMENTS

In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as represented in the drawings, is not intended to limit the scope of the invention, but is merely representative of the various embodiments of the invention.

In this description and the claims that follow, singular forms such as “a,” “an,” and “the” include plural forms unless the content clearly dictates otherwise. All ranges disclosed herein include, unless specifically indicated, all endpoints and intermediate values. In addition, “optional” or “optionally” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

### Polysiloxanes

Any suitable polysiloxane or combination of polysiloxanes may be used. For example, suitable polysiloxanes may include PDMS or combination of PDMS elastomer bases and cross linking agents, may be used. For example, Sylgard 184 (available from Dow Corning) may be used.

Suitable bases may include, for example, a base comprising 30 to 60 weight percent dimethylvinylated and trimethylated silica, 1 to 5 weight percent tetra(trimethylsiloxy)silane, and balance dimethyl siloxane, dimethylvinyl-terminated.

Suitable curing agents may include, for example, a curing agent comprising 40 to 70 weight percent dimethyl methylhydrogen siloxane, 15 to 40 weight percent dimethyl siloxane dimethylvinyl-terminated, 10 to 30 weight percent dimethylvinylated and trimethylated silica, and 1 to 5 weight percent tetramethyl tetravinyl cyclotetrasiloxane.

In embodiments, the volume ratio of base to curing agent may be within the range of one to twenty parts base to one part curing agent. Such a ratio may result in attaining the desired entanglement molecular weight of the PDMS matrix and accordingly desired surface segregation of said polymeric surfactant of different molecular weights.

### Surfactant

Suitable surfactants may include polyethylene oxide (PEO) polymeric surfactant additives or combinations of such components. The surfactant may be a PDMS-PEO copolymer. Suitable surfactants include, for example, the copolymers listed in Table 1.

TABLE 1
Summary of Composition and Geometry of PDMS-PEO Amphiphilic Block Copolymers

| | Molecular | % Non- | | |
|---|---|---|---|---|
| Block Copolymer | Weight | siloxane | Structure | Source |
| PDMS-b-PEO 600 PDMS-b-PEO 600 (G) PDMS-b-PEO 1000 PDMS-b-PEO 3000 PDMS-b-PEO 3000 (G) PDMS-b-PEO 10000 | 600 560-590 900-1000 3000 2500-3500 8000-12000 | 75 60-70 80 80 50-55 25 | 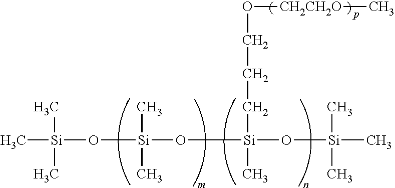 | Polysciences, Inc. Gelest, Inc. Gelest, Inc, Polysciences, Inc. Gelest, Inc. Gelest, Inc. |
| PDMS-b-PEO 5000 | 4500-5500 | 85-90 | 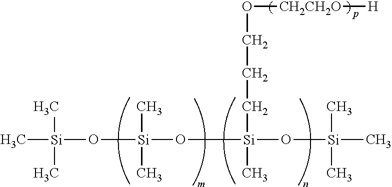 | Gelest, Inc. |
| PDMS-b-PEO 600 (I) | 500-700 | -* | 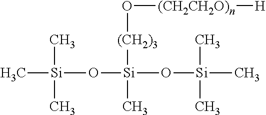 | Gelest, Inc. |
| PDMS-PEO 1000 | 900-1000 | -† | 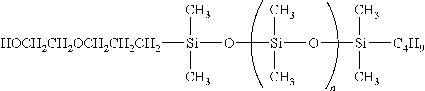 | Gelest, Inc. |
| PEO-PDMS-PEO 4000 PEO-PDMS-PEO 4000 | 3500-4500 1000-1250 | 60 -‡ | 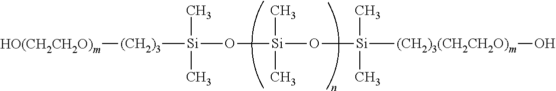 | Gelest, Inc. Gelest, Inc. |

*PDMS-b-PEO 600 (I) is a symmetric amphiphilic block copolymer, where PDMS chain is composed of just two dimethylsiloxane units.
†PDMS-PEO 1000 contains two ethyleneoxide (EO) units.
‡PEO-PDMS-PEO 1000 contains two ethyleneoxide (EO) units, i.e. m-1 in structural formula.

In the above formulas, the variables p, m, and n each independently represent an integer of 1 or more so that the molecular weight is approximately that which is listed.

In particular, the following illustrated PDMS-PEO surfactants may be used:

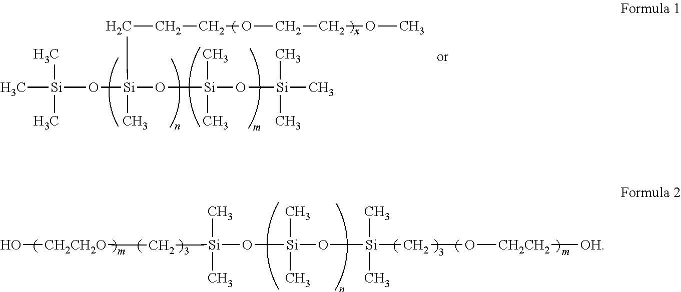

In Formulas 1 and 2, the subscripts, x, n, m, defining chain segment lengths, which may be varied to control the hydrophobic/hydrophilic balance and degree of modification of the PDMS monolith.

In Formula 1, x may represent an integer of at least 1, or represent a range, such as about 1-60, about 40-50, or about 5-7, that increases with molecular weight of the surfactant hydrophilic domain; n may represent an integer of at least 1, or a range, such as about 1-60, about 40-50, or about 5-7, that indicates the number, or statistical mean, of hydrophilic side chains; and m may represent an integer of at least 1, or a range such as about 1-60, about 40-50, or about 5-7, that increases with the molecular weight of the hydrophobic domain of the surfactant.

In Formula 2, there are only two variables due to the symmetric nature of the surfactant; n may represent an integer of at least 1, such as about 1-60, about 40-50, or about 5-7, in proportion to the molecular weight of the hydrophilic domain; and each m variable may independently represent an integer of at least 1, such as from about 1-60, about 40-50, or about 5-7, in proportion to the hydrophobic domain molecular weight.

Suitable molecular weights may include those illustrated in Table 1 ranging from about 600-12,000 daltons. As the molecular weight of the surfactant increases, material properties may be adversely affected, such as a decrease in the optical clarity for higher molecular weight surfactants that form domains throughout the bulk of the polymer.

### One-Pot Synthesis Applications

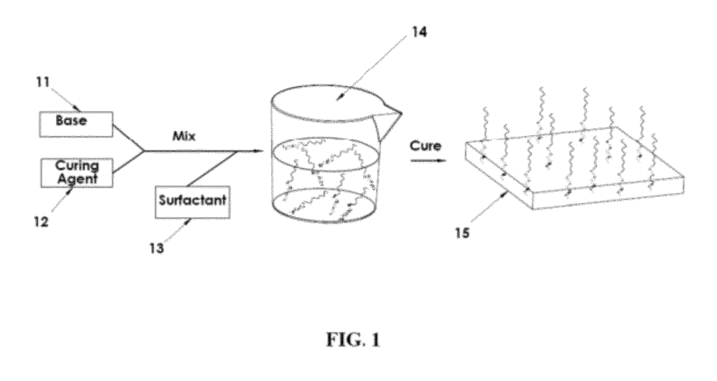

The surfactant may be combined with the polysiloxane, such as a PDMS base and curing agent, during polymerization as illustrated in FIG. 1. In FIG. 1, a PDMS polymer base 11 is mixed with a curing agent 12 and a surfactant 13 added. The mixture 14 is stored at the appropriate temperature for a period of time and then cured to produce a modified polysiloxane elastomeric monolith 15 with desired hydrophilic properties.

Any suitable mixing ratio of components may be used. For example, mixing ratios of 10:1:(0.1 to 0.5) (PDMS base:curing agent:polymeric surfactant additive) may be used. The surfactant may be added in an amount equal to between 0.1 to 0.5 volume parts to PDMS base polymer to attain desired hydrophilicity or to attain desired optical properties.

After mixing, the mixture may be allowed to stand at temperatures ≦4° C. for 12-18 hrs to aid in removing any air bubbles. Centrifugation and vacuums may also be employed to remove entrapped air.

After removing air bubbles, the mixture may be heated to any suitable temperature, such as temperatures ≧60° C. to facilitate cross-linking and formation of the hydrophilic PDMS monolith.

Here, van der Waals force and hydrophobic interactions between the PDMS monolith and PDMS segments in polymeric surfactant additives stabilize the surfactant at the polymer surface, resulting in a hydrophilic coating. The surface fraction of PEO on the PDMS surface may be controlled by the cross-linking density of the PDMS matrix and concentration, geometry and hydrophilic-lipophilic balance (HLB) of PEO containing polymeric surfactant additives used in the modification procedure. Further, optical properties of the formed PDMS monoliths are controlled through the concentration of polymeric surfactant additive and PEO fraction of the polymeric surfactant additive used.

Applicable surfactants, such as a polymeric surfactant may be an amphiphilic block copolymer or an end functionalized polymer. This polymeric surfactant additive may be a linear or branched polymer. It may be comprised of a hydrophobic segment, or anchor, which is compatible with the base elastomer (e.g. PDMS) and serves to solubilize the additive within the elastomer matrix during preparation, and later serves to anchor the additive in the cured PDMS. The additive may also be comprised of a hydrophilic pendant chain(s), which imparts) desirable surface properties to the formed elastomer monolith, where van der Waals forces and hydrophobic interactions between the PDMS base polymer and polymeric surfactant additive are sufficient to lead to a stable hydrophilic surface.

A key determinant factor for diffusion and surface segregation of the polymeric surfactant additive may be the entanglement molecular weight of the PDMS matrix, which is dependent on the cross-linking ratio, and molecular weight of the polymeric surfactant additive used. The effectiveness of the polymeric surfactant to impart the desired hydrophilicity depends on molecular weight, geometry and HLB of the particular surfactant. The optical properties also depend on the fraction of PEO segment present in the polymeric surfactant with a higher PEO fraction correlating to a lower transparency of the synthesized PDMS monolith. The stability of the hydrophilic character of the PDMS monolith synthesized by this process is dependent upon the environment in which the synthesized samples are stored and the solubility of the polymeric surfactant in the surrounding environment

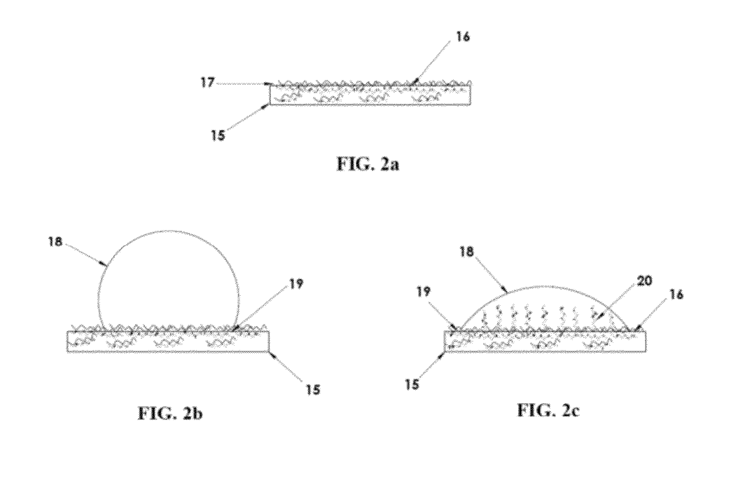

FIGS. 2a, 2b, and 2c are schematic illustrations of the time dependent water contact angle behavior of the modified PDMS. FIG. 2a shows the modified PDMS elastomeric monolith 15 with a surface segregated surfactant 16 at the polymer/air interface 17, resulting in the minimization of the interfacial free energy. FIG. 2b represents the instant at which the modified PDMS elastomeric monolith 15 comes in contact with a water droplet 18 and a polymer/water interface 19 is formed. The system exhibits hydrophobic behavior at this moment. FIG. 2c shows the water droplet 18 on the modified PDMA elastomeric monolith 15 after a period of time. The surfactant 16 is adsorbed and reorients 20 towards the polymer/water interface 19. This acts to minimize the interfacial free energy and reduces the water contact angle, thus producing a hydrophilic surface.

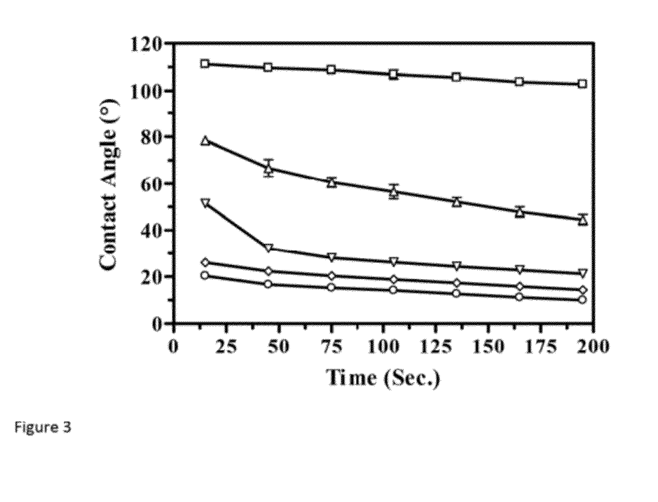

FIG. 3 shows is a graph of experimental data showing the surface becoming more hydrophilic with time for a constant amount of surfactant added. FIG. 3 also shows that for a constant time, the hydrophilic nature of the modified PDMS increases with increasing amount of surfactant.

### Molding Applications

The partitioning of surfactant additive to the PDMS surface during curing may be further controlled by defining the properties of the interface, whether it is, for example, polymer/solid, polymer/gas, or polymer/liquid. The solid surface may represent a mold or template for forming a contact lens or microfluidic chip or microcontact stamp, as representative but not exclusive examples. Modification of these surfaces with said polymer additives (surfactants) prior to addition of an elastomer/base mixture is encompassed herein and described further below.

The surfactants (co-polymers) and their combinations described above as additives for a one-pot synthesis of hydrophilic PDMS may also be used as mold release agents that are incorporated into the surface of curing PDMS. The PDMS-PEO copolymers may be anchored to the surface of the curing PDMS through hydrophobic interactions and chain entanglement.

The same polysiloxanes or combination of polysiloxane components as described above for the one-pot synthesis may be used in this application.

Standard molds, such as aluminum molds, may be coated with a thin film of the surfactant(s), whose thickness can be controlled through any suitable method, such as dip coating, spin coating, deposition from volatile solvents, and temperature during application.

Non-traditional molds made from polysiloxanes, PDMS, or other polymers, whose cross-linking density and porosity is controlled, may serve as an additional means to control the concentration of the PDMS-PEO mold release surfactants and may serve as a reservoir or “ink pad” type mold that transfers the PDMS-PEO surfactant into the curing PDMS polymer on top of the mold. Such molds may permeated with surfactant and later be re-filled or “re-inked” with surfactant, either from a top-down or a bottom-up approach, and may be used to allow for continuous refilling of the mold whose backside is in contact with a reservoir of PDMS-PEO copolymers. The surfactant impregnated mold transfers PDMS-PEO through the mold. Such a transfer may be facilitated or accelerated through application of a vacuum to the top surface of the mold to pull the surfactant through. Alternatively, the surfactant may be pulled through the mold by hydrophobic and/or hydrophilic forces. Thus, the molds may be regenerative in nature and the PDMS-PEO component may be pulled to the surface of the mold for transfer to the molded product to impart hydrophilic and other desired properties.

The depth of penetration of the PDMS-PEO copolymers into the PDMS that is being molded may be controlled by tuning the curing rate of the molded PDMS through temperature, pressure, and ratio of base to initiator of the PDMS. For example, the temperature of the PDMS-PEO coated mold during application of the premixed PDMS base/initiator determines the rate of cure and thus controls the rate of PDMS-PEO diffusion into the curing polymer. Both diffusion and cure rate increases with temperature. Thus, if the temperature is decreased, the curing rate is decrease and a deeper diffusion of the PDMS-PEO coated on the mold is permitted. Suitable curing temperatures include, for example, temperatures from about 20° C. to 150° C., such as about 30° C. to 125° C., or about 50° C. In addition, negative or positive pressure may be applied to pull or push the PDMS-PEO component through the PDMS matrix.

In addition, the properties of the PDMS-PEO component may also affect the depth of penetrations. Lower molecular weighted PDMS-PEOs may be employed to facilitate the diffusion of the PDMS-PEO into the PDMS matrix during curing. Suitable molecular weights for the PDMS-PEO component include, for example, less than 1200 daltons, such as about 600 daltons. Thus, lower molecular weight surfactants will diffuse faster. In addition, longer PEO chains on the surfactants compared to the PDMS chains will increase hydrophilicity. Longer surfactant PDMS chains will allow for greater network interpenetration (entanglement or anchoring of surfactant PDMS chains with the base PDMS chains).

The following examples are illustrative only and are not intended to limit the disclosure in any way.

### Example 1

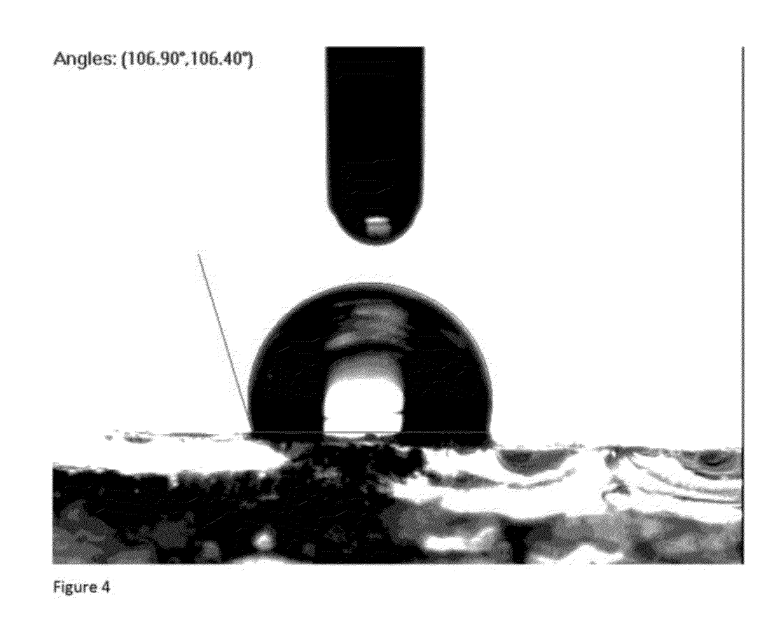

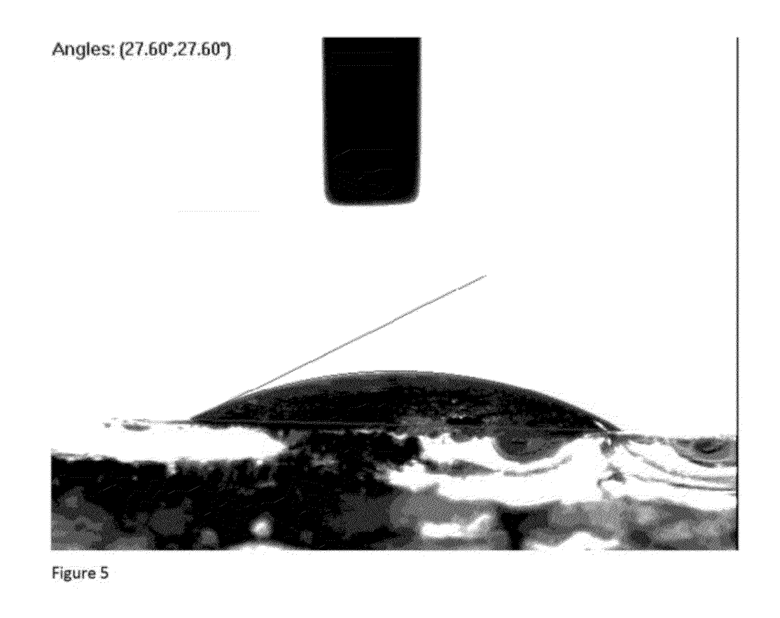

Using PDMS-PEO copolymers as mold release agents on Aluminum molds PDMS (Sylgard 184) was cured in a 10:1 base to initiator ratio on molds heated at a temperature of from 20° C. to 150° C. Cure times are temperature dependent and this allows the penetration depth of PDMS-PEO into the curing PDMS to be controlled. Samples were rinsed with tap water, ethanol, double distilled water, and soaked in water for 24 h followed by air drying and analysis of hydrophilcity using standard water contact angle analysis. The results are illustrated in FIGS. 4 and 5. The surfaces are dynamic as indicated by an initial water contact angles of 1 microliter droplets of around 107 degrees, as illustrated in FIG. 4. Within 1 minute of contact time on the surface the water droplet decreases to below 28 degrees, as illustrated in FIG. 5.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed:

1. A method for making a hydrophilic polysiloxane elastomer, the method comprising:
mixing a polysiloxane elastomer base with a polysiloxane elastomer curing agent to form a mixture;
placing the mixture in a mold coated or permeated with a surfactant; and
curing the mixture in the mold.

2. The method of claim 1, wherein the surfactant comprises a polymeric surfactant.

3. The method of claim 1, wherein the surfactant comprises a PDMS-PEO copolymer.

4. The method of claim 1, wherein the surfactant comprises 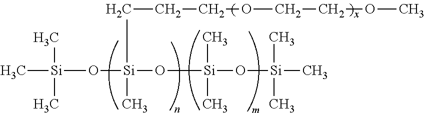
wherein
x is 1-60,
n is 1-60, and
m is 1-60.

5. The method of claim 1, wherein the surfactant comprises 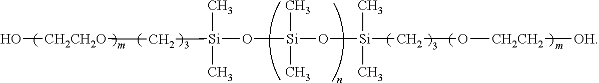
wherein
n is 1-60, and
each m is independently 1-60.

6. The method of claim 1, wherein the polysiloxane is polydimethylsiloxane.

7. The method of claim 1, wherein the polysiloxane elastomer base comprises a polydimethylsiloxane base comprising 30 to 60 weight percent dimethylvinylated and trimethylated silica, 1 to 5 weight percent tetra(trimethylsiloxy)silane, and balance dimethyl siloxane, dimethylvinyl-terminated.

8. The method of claim 1, wherein the polysiloxane curing agent comprises a polydimethylsiloxane curing agent comprising 40 to 70 weight percent dimethyl methylhydrogen siloxane, 15 to 40 weight percent dimethyl siloxane dimethylvinyl-terminated, 10 to 30 weight percent dimethylvinylated and trimethylated silica, and 1 to 5 weight percent tetramethyl tetravinyl cyclotetrasiloxane.

9. The method of claim 1, wherein the mixture is cured at a temperature of from about 20° C. to 150° C.

10. The method of claim 1, wherein the mold comprises aluminum and is coated with the surfactant.

11. The method of claim 1, wherein the mold comprises polydimethylsiloxane and is coated with the surfactant.

12. The method of claim 1, wherein the mold is coated with the surfactant by dip coating, spin coating, or deposition from volatile solvents.

13. The method of claim 1, wherein the mold comprises polydimethylsiloxane and is permeated with the surfactant.

14. The method of claim 13, wherein the surfactant is selected from the group consisting of 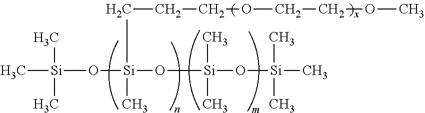
wherein
x is 1-60,
n is 1-60, and
m is 1-60; and 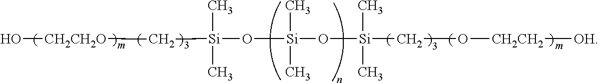
wherein
n is 1-60, and
each m is independently 1-60.

15. A mold for molding polysiloxane, comprising a mold coated or permeated with a surfactant.

16. The mold of claim 15, wherein the mold comprises aluminum.

17. The mold of claim 15, wherein the mold comprises polysiloxane.

18. The mold of claim 15, wherein the surfactant is a PDMS-PEO copolymer.

19. The mold of claim 15, wherein the surfactant is selected from the group consisting of 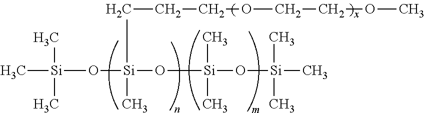
wherein
x is 1-60,
n is 1-60, and
m is 1-60; and 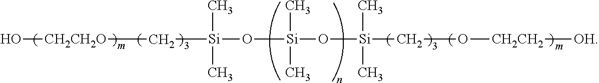
wherein
n is 1-60, and
each m is independently 1-60.

20. The mold of claim 15, wherein the mold comprises PDMS and may be re-filled with surfactant.
